(19) United States
(12) Patent Application Publication
(10) Pub. No.: US 2024/0283487 A1
(43) Pub. Date: Aug. 22, 2024

(54) IDENTIFYING AND DECODING MULTIPLE NFC RESPONSES FOLLOWING NFC INVENTORY REQUEST

(71) Applicant: Tektronix, Inc., Beaverton, OR (US)

(72) Inventors: P. E. Ramesh, Bangalore (IN); Praharsha P Sirsi, Bangalore (IN)

(21) Appl. No.: 18/582,360

(22) Filed: Feb. 20, 2024

(30) Foreign Application Priority Data
Feb. 22, 2023 (IN) 202321012113

(51) Int. Cl. H04B 5/73; H04B 5/43

(52) U.S. Cl. CPC H04B 5/73; H04B 5/43

(57) ABSTRACT

A test and measurement system includes a radio frequency antenna structured to receive a wireless carrier signal generated by an NFC vicinity coupling device and to receive load-modulated wireless carrier signals generated by one or more vicinity integrated circuit cards in response to the wireless carrier signal, and a response detector structured to determine if any load-modulated wireless carrier signals generated by one or more vicinity integrated circuit cards were received by the antenna. The response detector may use cross-correlation to determine if the load-modulated wireless carrier signals are present.

### CROSS-REFERENCE TO RELATED APPLICATIONS

This disclosure claims priority under 35 U.S.C. § 119 to Indian Provisional Patent Application No. 202321012113, filed Feb. 22, 2023, titled “METHOD TO GET IEC15693 AND IEC14443A STANDARD RESPONSE FOR OSCILLOSCOPE BASED NFC DECODING,” the disclosure of which is incorporated herein by reference in its entirety.

### TECHNICAL FIELD

The present disclosure relates generally to test and measurement systems and methods and, more particularly, to identifying and decoding multiple responses from Near Field Communication (NFC) devices during testing.

### BACKGROUND

Near Field Communication (NFC) is a series of wireless communications protocol standards defining communication between two electronic devices spaced a short-range from one another. NFC provides communication between two NFC-enabled electronic devices through a wireless carrier signal and magnetic field coupling of two antennas on the two NFC-enabled electronic devices. Many different types of electronic devices utilize NFC in a wide variety of applications such as mobile payments and radio frequency identification (RFID) tags for applications such as access authentication for doors of residential and commercial buildings as well as vehicles. NFC-enabled electronic devices may be passive devices like RFID tags or active devices like smartphones or payment terminals that initiate a communication session with a proximate passive device. This communication is termed “near field” communications because the distance between two devices is much less than the length of a wavelength of the wireless carrier signal. For example, when the wireless carrier signal is a 13.56 MHz carrier signal, the wavelength is approximately twenty-two (22) meters while typical distance between the polling and listening NFC-enabled devices is on the order of 10 cm or less.

A typical NFC system includes a Vicinity Coupling Device (VCD) and a Vicinity Integrated Circuit Card (VICC). The VCD may also be referred to as a “reader” or “polling device” and the VICC referred to as a “tag” or “listening device” in the present description. The VCD and VICC are magnetically coupled to wirelessly communicate through one of the NFC standard communication protocols, with the VCD modulating an amplitude of a carrier signal to communicate commands to the VICC and the VICC decoding and responding to these commands through load modulation. Different types of load modulation are utilized in different NFC standards. NFC-A type devices communicate according to the ISO/IEC 14443A standard in which a VCD utilizes amplitude modulation to send commands to a VICC which, in turn, responds to these commands utilizing on-off keying (OOK) for the load modulation, where OOK is a type of amplitude-shift keying (ASK). NFC—B type devices communicate according to the ISO/IEC 14443B standard in which a VCD utilizes amplitude modulation to send commands to a VICC and the VICC utilizes load modulation to generate a binary phase shift keying (BPSK) modulated signal to respond to these commands. Other NFC protocols include ISO/IEC15693 and FELICA.

The number of applications in which NFC is being utilized is ever increasing, and in each such new application the testing of NFC-enabled devices is important to ensure proper operation. One problem that occurs when multiple NFC-enabled devices are in proximity with one another is that, after a VCD sends a command to nearby VICCs, such as an inventory request, all of the VICCs within proximity of the VCD send a response. Although the NFC protocols prevent the individual responses from VICCs from colliding with one another, the same protocols allow for some pre-defined response slots to be empty. Therefore, an empty response time slot cannot be assumed to be the end of the VICC responses.

Present measurement devices use a spectrum analyzer to measure the Radio Frequency (RF) responses from local VICCs being tested and then use a vector signal analyzer to convert the response to an IQ waveform for further measurement. This test system, however, is limited to tracking and decoding only a single NFC transaction.

Accordingly, there is a need for improved testing techniques of demodulating wireless signals which may be implemented in test and measurement instruments like oscilloscopes or other devices to enable the instruments to conduct, for example, testing of NFC-enabled devices.

### BRIEF DESCRIPTION OF ACCOMPANYING DRAWINGS

FIG. 1 illustrates a test and measurement system including a test and measurement instrument having an antenna for receiving RF signals, memory to store the received RF signals as a waveform, a detector for isolating NFC responses, and a decoder for decoding the detected responses in accordance with some embodiments of the present disclosure.

FIGS. 2A and 2B together form a timing chart that illustrates behavior of an NFC system including a Vicinity Coupling Device as well as multiple polling devices in accordance with embodiments of the present disclosure.

FIG. 3 is a flowchart of an example process used by the detector for isolating NFC responses and the decoder for decoding the detected responses in accordance with embodiments of the present disclosure.

FIG. 4 illustrates an overall process for using cross-correlation to determine whether an NFC response is present according to embodiments of the disclosure.

FIG. 5 illustrates a received NFC signal after a DC component has been removed according to embodiments of the disclosure.

FIG. 6 illustrates a reference waveform used in a cross-correlation with the waveform of FIG. 5 according to embodiments of the disclosure.

FIG. 7 includes two tables of NFC decoded data that was decoded with the test and measurement instrument of FIG. 1 using embodiments of the disclosure.

FIG. 8 is an example display screen that may be shown on the test and measurement instrument of FIG. 1 showing results of the detection and decoding according to embodiments of the disclosure.

### DETAILED DESCRIPTION

Embodiments of the present disclosure are directed to methods and systems for detecting multiple tag responses from NFC devices that occur when a Vicinity Coupling Device (VCD) transmits a command, such as an inventory request, when it is proximate to several different NFC listening devices, such as Vicinity Integrated Circuit Cards (VICCs). Embodiments also include decoding data from data frames transmitted by both the VCDs and VICCs using spectrum processing in an oscilloscope, and then aligning and displaying the decoded data to the time domain signals that correspond to the signals in the frequency domain, thus allowing a user to view a very clear representation of the NFC communication as measured by the oscilloscope.

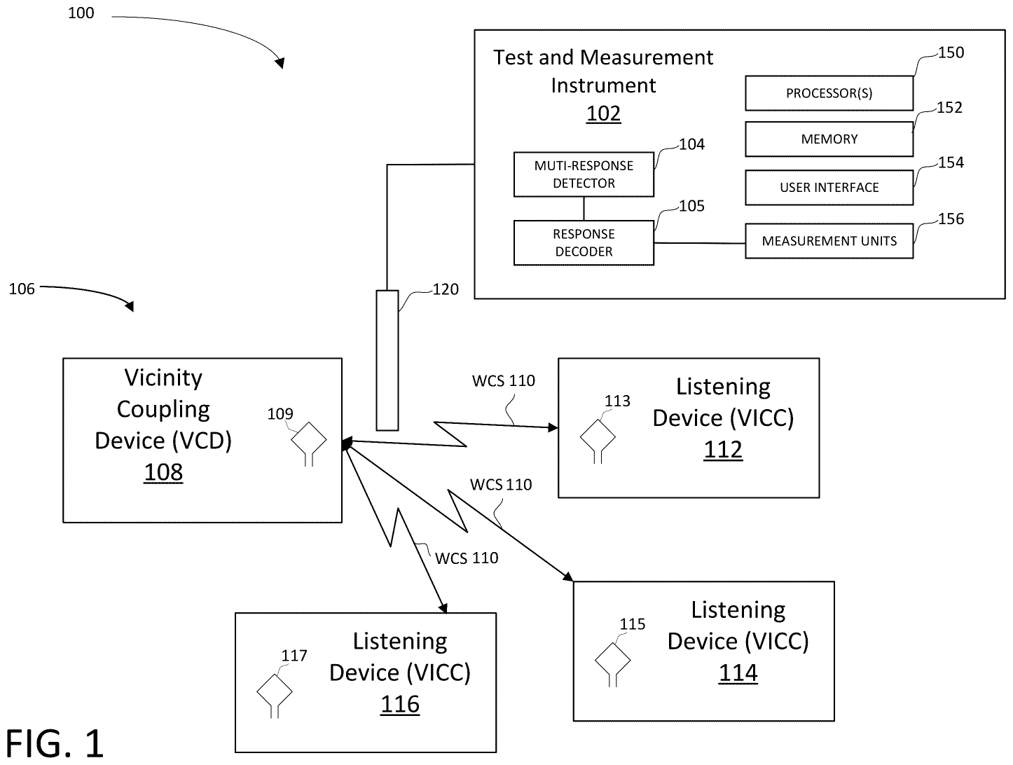

FIG. 1 is a block diagram of a test and measurement system 100 including a test and measurement instrument 102, such as an oscilloscope, that includes a multi-response detector 104 for detecting multiple responses from NFC-enabled device as well as a response decoder 105 for decoding the detected responses during testing of NFC-enabled devices 106 in accordance with embodiments of the present disclosure. Detailed description of the operation of multi-response detector 104 and the response decoder 105 with other components of the test and measurement system 100 appears below.

The test and measurement instrument 102 also includes one or more main processors 150 that may be configured to execute instructions from main memory 152 and may perform any methods and/or associated steps indicated by such instructions. Portions of memory 152 may also be configured as a waveform memory to store waveform data acquired by the instrument 102. Portions of memory 152 may also store other data. A user interface 154 is coupled to the one or more processors 150 and may include, for example, a keyboard, mouse, touchscreen, output display, file storage, and/or any other controls employable by a user to interact with the test and measurement instrument 102. In some embodiments the user interface 154 may be connected to or controlled by a remote interface (not illustrated), so that a user may control operation of the instrument 102 in a remote location physically away from the instrument. A display portion of the user interface 154 may be a digital screen such as an LCD, or any other monitor to display waveforms, measurements, and other data to a user. In some embodiments, the main output display of the user interface 154 may also be located remote from the instrument 102.

One or more measurement units 156 perform the main functions of measuring parameters and other qualities of signals from the devices being measured by the instrument 102. Typical measurements include measuring voltage, current, and power of input signals in the time domain, as well as measuring features of the input signals in the frequency domain. The measurement units 156 represent any measurements that are typically performed on test and measurement instruments, and the multi-response detector 104 and response decoder 105 may be integrated within or coupled to such measurement units 156.

FIG. 1 also illustrates NFC-enabled devices 106 include a polling device or Vicinity Coupling Device (VCD) 108 and listening devices 112, 114, 116, which may be referred to as Vicinity Integrated Circuit Cards (VICCs). Although three VICCs 112, 114, 116 appear in FIG. 1, embodiments of the invention operate with any number of VICCs in the vicinity of the VCD 108. In operation, the polling device 108 transmits NFC wireless carrier signal WCS 110 to both power and communicate commands to the listening devices 112, 114, 116, and the listening devices individually perform load modulation of the wireless carrier signal 110 to generate a response back to the VCD. These responses by the VICCs have a sub-carrier of 848 KHz carrier frequency of modulation.

A radio frequency (RF) probe, or antenna 120 is coupled to a testing input of the test and measurement instrument 102 and is suitably positioned proximate to one or more of the listening devices 112, 114, 116 to sense the wireless carrier signal WCS 110. Due to the limited range of NFC signals, the antenna is generally located within approximately 5-10 cm of the NFC-enabled devices 106. During testing of the NFC-enabled devices 106, the test and measurement instrument 102 captures the wireless carrier signal WCS 110 as sensed by the RF antenna 120. After these NFC signals have been captured by the instrument 102 as an input waveform, the multi-response detector 104 determines whether any responses have been made by the VICCs 112, 114, 116 and, if so, the responses are decoded by the response decoder 105 so that the instrument 102 may display the decoded responses on the user interface 154 for the user. In this way the user may use the instrument 102 to test and measure the NFC-enabled devices 106 in a manner not possible previously.

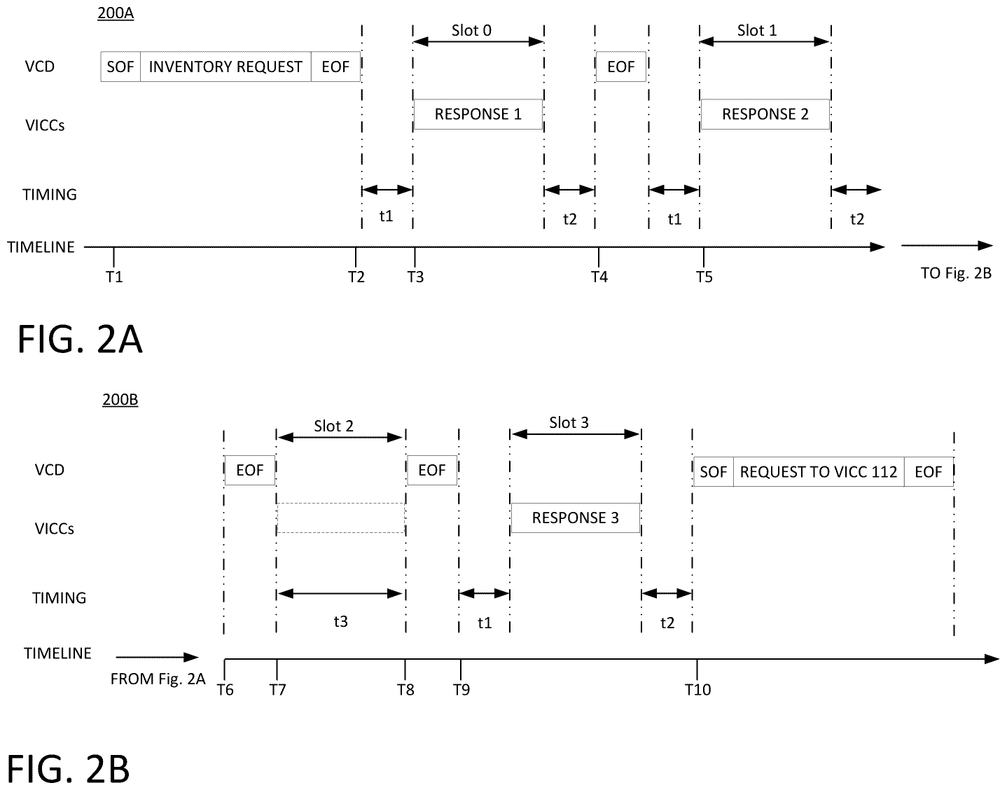

As previously mentioned, the polling device 108 and listening devices 112, 114, 116 communicate through NFC communications, with the wireless carrier signal WCS 110 representing this NFC communications in FIG. 1. The characteristics of the wireless carrier signal WCS 110 and NFC communications between the polling device 108 and listening devices 112, 114, 116 will now be briefly described in more detail with reference to FIGS. 1, 2A, and 2B in order to better explain the operation of the multi-response detector 104 and the response decoder 105 according to embodiments of the present disclosure. Each of the polling and listening devices 108, 112, 114, and 116 includes its own antenna 109, 113, 115, and 117, respectively, as illustrated in FIG. 1. Each antenna is coupled to electronic components (not shown) in the corresponding polling or listening devices 108, 112, 114, 116. These antennas 109, 113, 115, 117 are physically positioned proximate one another so that the antennas are inductively coupled through the wireless carrier signal WCS 110 in the same way as are inductors of a transformer. The antennas 109, 113, 115, 117 may thus be viewed as coils of an air core transformer, with the wireless carrier signal WCS 110 representing an alternating magnetic field that is generated by the polling device 108 through an alternating signal applied to its antenna 109. This alternating signal is generally a 13.56 MHz carrier signal as specified by NFC protocol standards, although carrier signals of other frequencies may also be used within the scope of the present disclosure. Those skilled in the art will understand the characteristics of the magnetic coupling and NFC between the antennas 109, 113, 115, 117 of the polling and listening devices 108, 112, 114, 116 relative to conventional far field propagation of electromagnetic signals between antennas. Accordingly, the characteristics of NFC are discussed briefly herein but are not described in detail and such details are not necessary for an understanding of embodiments of the present disclosure.

In general, for background, NFC communication begins by the polling device, or VCD 108 generating a command, in the form of a signal on the wireless carrier signal WCS 110, which is propagated by the antenna 109 to the neighboring NFC listening devices, or VICCs 112, 114, 116. The VICCs 112, 114, 116 receive the wireless carrier signal WCS 110 and demodulate the signal to decode the command sent by the VCD 108. The VICCs 112, 114, 116 each then process the decoded command and send an appropriate response corresponding to the decoded command within a certain timeframe. In more detail, the VICCs 112, 114, 116 send the response by load modulating the wireless carrier signal WCS 110. Load modulation varies an impedance of the antennae 113, 115, 117 of the listening devices 112, 114, 116 and, due to the magnetic coupling of the antennas, this variation of impedance of the antenna 113, 115, 117 causes a change in the signal at the antenna 109 of the polling device 108. In this way, the listening devices 112, 114, 116 modulate the wireless carrier signal WCS 110 to send a response to the polling device 108. According to many of the NFC device protocols, the listening devices 112, 114, 116 use a subcarrier at 848 KHz that is modulated through particular keying, such as amplitude shift keying or binary phase shift keying. Thus, the listening devices 112, 114, 116 load modulate the wireless carrier signal WCS 110 to include the key-modulated subcarrier signal containing the response to the command sent by the polling device 108. As described in more detail below, embodiments according to the disclosure use a multi-response detector 104 (FIG. 1) to detect each response from the listening devices 112, 114, 116 made in response to a command of the polling device 108, as well as a response decoder 105 (FIG. 1) that decodes each of the detected responses.

An example NFC communication session is represented in FIGS. 2A and 2B. FIG. 2A illustrates a first portion of the NFC communication session 200A, while FIG. 2B illustrates a second portion of the NFC communication session. In other words, the NFC communication session starts with the operations illustrated by 200A in FIG. 2A and carries over to the operations illustrated by 200B in FIG. 2B. Although illustrated through two figures, the session is continuous in time.

The NFC communication session begins with VCD 108 initiating an inventory request command and sending the command from its antenna 109 to any NFC antenna that is nearby. In FIG. 1, the commands sent by the VCD 108 will be sensed by the respective antennas in the VICCs 112, 114, 116. Referring back to FIG. 2A, the inventory request command is preceded by a start-of-frame (SOF) signal and is concluded by an end-of-frame (EOF) signal sent by the VCD 108 between times T1 and T2. These SOF and EOFs signals are particular codes sent by the VCD 108 through the WCS signal 110 and are defined as a part of the NFC standards, so that all of the NFC-enabled devices 112, 114, 116 are able to decode the SOF and EOF signals and understand their use within the established NFC protocols.

Still referring to FIG. 2A, when the VCD 108 is proximate one or more of the VICCs 112, 114, 116, the wireless carrier signal WCS 110 is received by the respective antenna in each VICC. This receipt of the wireless carrier signal WCS 110 and generation of power therefrom corresponds to receiving the inventory request command sent by the VCD 108 of FIG. 2A. After the inventory request command is sent from the VCD, each of the VICCs within range of the antenna 109 of the VCD 108 (FIG. 1) prepares to send a response, as illustrated in FIGS. 2A and 2B. As described above the NFC protocols include rules to prevent two VICCs responding to the inventory request command at the same time. In other words, there will be no collisions between the VICC responses. So, after a time period t1 after receiving the inventory request command from the VCD 108, one of the VICCs, for example VICC 112 generates and sends at T3 a response, “Response 1”, using the process described above, i.e., load modulation. Note that Response 1 occurs at the first timeslot, response Slot 0, after the EOF that ended at T2. The VCD 108 indicates that it has received Response 1 to the VICC 112 (as well as the other VICCs 114, 116 in the vicinity of VCD 8) by sending the EOF signal at T4. Then, the next VICC, for example VICC 114 prepares and sends its response, “Response 2” at T5, during response Slot 1, and again the VCD acknowledges receipt of the Response 2 by sending an EOF signal at T6 on the timeline. Differently, after the EOF signal sent at T6, none of the VICCs 112, 114, 116 send any response during Slot 2, i.e., the time period between T7 and T8 on the timeline. This is due to the non-collision rules in the NFC protocols. The VCD sends another EOF at T8, after which a VICC, in this case VICC 116 sends its “Response 3” in response Slot 3. After receiving Response 3 in response Slot 3, the VCD sends a command request directly to VICC 112 beginning at T10 on the timeline. Even though there may be many variations on sending and receiving requests between a VCD and one or more VICCs, the example set out in FIGS. 2A and 2B illustrate one of the problems solved by embodiments of the disclosure, which is to be able to identify whether any VICC has sent a response in a particular response timeslot. That is, embodiments of the disclosure include an instrument having a detector 104 that can determine multiple responses by VICCs that are proximate to and respond to a VCD command.

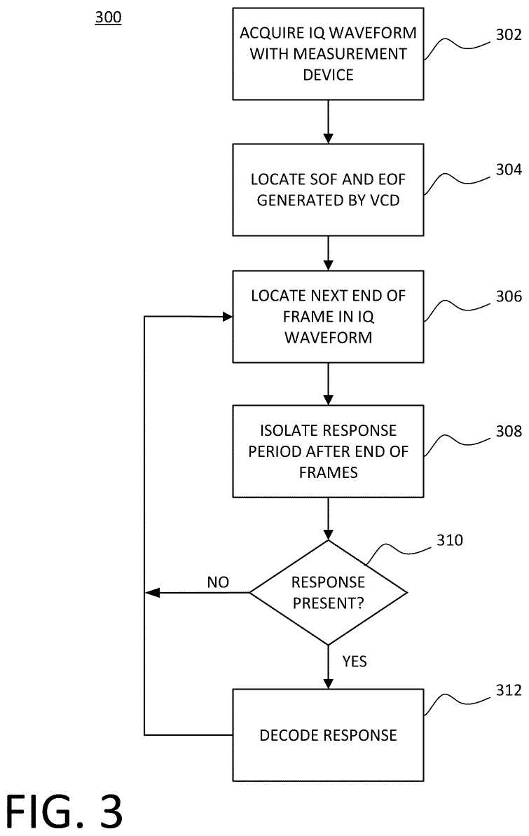

FIG. 3 is a flowchart of an example process 300 executed by the multi-response detector 104 and response decoder 105 of FIG. 1 in accordance with some embodiments of the present disclosure. The process 300 will now be described in more detail with reference to FIGS. 1-8. The process 300 begins at operation 302 in which the test and measurement instrument 102 acquires a signal from the antenna 120 and converts it into a digitized waveform for processing. The antenna 120 is a radio frequency (RF) antenna tuned or otherwise able to detect signals in the frequency band in which NFC devices operate. Embodiments according to the disclosure analyze this digitized waveform which allows the instrument 102 to make measurements and decode responses made in an NFC communication system that includes a polling device and one or more listening devices such as those described above. Note that in the testing system 100 of FIG. 1 that the test and measurement instrument 102 is not physically connected to any of the NFC devices 106, but that the antenna 120 acquires the input signal “over the air”, i.e., through radio frequency signals sensed by the antenna. This also means that the measurement system 100 does not alter the NFC devices 106 in any way, nor are any special devices needed to test and measure the NFC system. The operation 302 describes that it acquires an IQ waveform, which means that the RF signal detected by the antenna 120 is converted by the test and measurement instrument 102 into its I (in-phase) and Q (quadrature) components, which is commonly called an IQ waveform. Generally, this conversion is performed by applying a center frequency to the signal to derive the IQ components. This IQ waveform is stored in the memory, such as the waveform memory 152 of the instrument 102. In some embodiments the instrument 102 includes enough memory 152 to store many seconds, such as 5 or 10 seconds of IQ waveform data that was detected by the antenna 120 during an NFC communication session.

With reference to FIGS. 3 and 2A, operations 304, 306, 308, and 310 are now described, which are performed by the multi-response detector 104 of FIG. 1. As described above, FIG. 2A illustrates a timing diagram of an example inventory request command sent from the VCD, such as VCD 108 and answered by three VICCs, such as VICCs 112, 114, 116. It is known in NFC systems that the energy of the signals sent by polling devices, such as VCD 108, use approximately 90% of the modulation energy of the signal, such as the wireless carrier signal WCS 110 of FIG. 1. Embodiments of the disclosure use this disparity in signal strengths to help locate when a VICC generates a response. In other words, embodiments as disclosed herein first identify characteristics of the signals sent from the VCD to help locate within the IQ waveform where responses from the VICCs are most likely to be, and then search those portions of the IQ waveform to determine if a response is present. And, if the response is present, embodiments also automatically decode the response and present it to the user of the testing system 100, as described in more detail below.

Returning back to FIG. 3, operation 304 of the process 300 locates a next “start of frame” signal that was generated by the VCD. The instrument 102 (FIG. 1) detects signals generated by the VCD based on its amplitude, as the VCD devices have a large amplitude when they transmit data. In one embodiment the detected amplitude is compared to a threshold, and, if the amplitude is above the threshold, the instrument determines that the transmission originated from a VCD. In some embodiments the process 304 also (or instead of) identifies the “end of frame” EOF signal that follows the SOF signal generated by the VCD. With reference back to FIG. 2A, recall that the VCD generates a SOF (start of frame) signal at times T1 and T10, both before any responses have been received from the VICCs (T1) and after all of the responses have been received (T10). The operation 304 of FIG. 3 identifies at least the SOF signal at T1, and, in some embodiments, identifies the SOF signal at T10 as well, in which case the portion of the saved IQ waveform that may contain the VICC responses is fully identified. As will be described below, it is not completely necessary that operation 304 identify the SOF at T10, because operation 306 of the process 300 (FIG. 3) locates the next EOF signal that follows the SOF signal at T1. In other words, with reference to FIG. 2A, the operation 304 first locates the SOF signal at T1, and then the operation 306 locates the EOF signal that ends at T2. Next, an operation 308 isolates the response period that falls between two EOF signals sent from the VCD. With reference to FIGS. 2A and 2B, note that each response period from the VICCs falls in a response Slot n, and that each response Slot n is located between two EOF signals that were generated by the VCD. The operation 308 isolates the Slot n responses in the IQ waveform and identifies those areas as potentially containing a VICC response.

So, up to this point, the process 300, and particularly operations 302-308, has identified regions of the stored IQ waveform where responses, if present, are located in the stored IQ waveform. A next operation 310 determines whether a response from one of the VICCs in the vicinity of the VCD is present, as described with reference below.

In general, embodiments of the disclosure use a cross-correlation process to determine whether the identified locations in the IQ waveform that may include a VICC response actually contain the response or not.

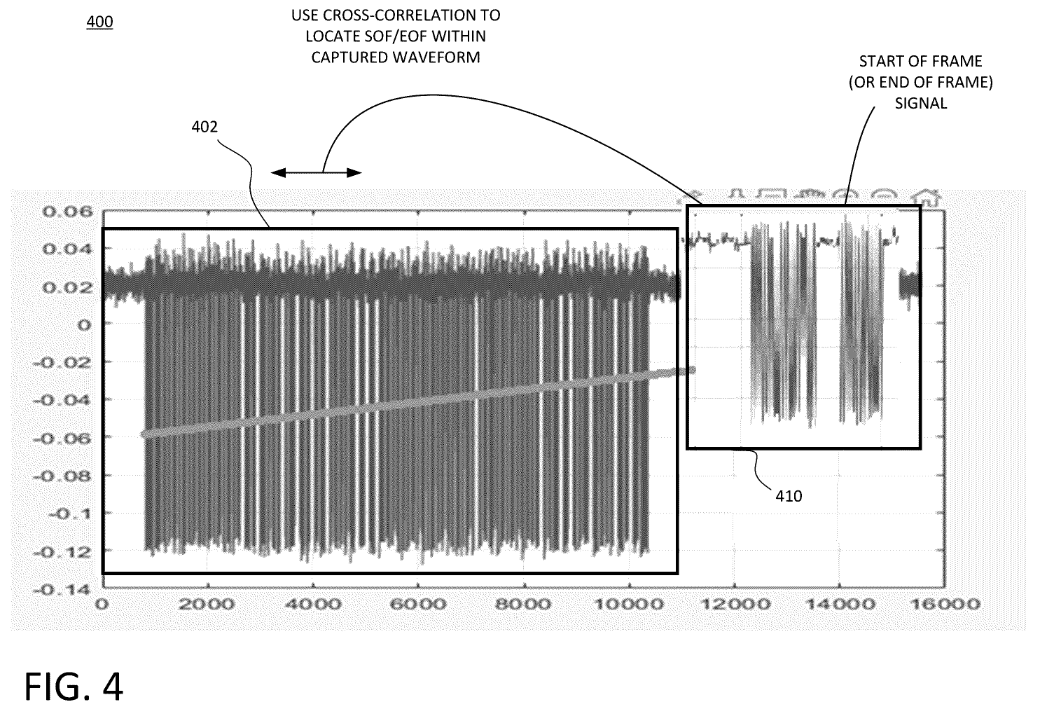

FIG. 4 illustrates an overall process 400 for using cross-correlation to determine whether a response is present. In the process 400, the stored waveform acquired by the instrument 102 (FIG. 1) in the operation 302 (FIG. 3) is represented as reference 402. Also, a standard or reference SOF signal from the VICC is illustrated as reference 410. Referring back to FIGS. 2A and 2B, each response from any of the VICCs, i.e., Response 1, Response 2, and Response 3, all contain a SOF signal and an EOF signal, even though they are not illustrated, for clarity. The SOF and EOF signals in the VICC responses may be different signals than the SOF and EOF signals generated by the VCD described above. One difference between the VCD signals and the VICC responses is that the VICC responses are carried on a subcarrier signal centered at 848 KHz, while the VCD commands are carried on a 13.56 MHz carrier signal. Thus, the operation 310 of FIG. 3 determines whether a VICC response is present by determining if the response period isolated by operation 308 contains a VICC SOF signal. And, more specifically, the operation 310 of FIG. 3 determines whether a VICC response is present by performing a cross-correlation operation between the SOF signal 410 and a modified version of the stored waveform 402. Both the cross-correlation operation and the modifications made to the waveform 402 are described in more detail below.

To prepare the stored waveform 402 for the cross-correlation process, first the stored waveform captured and stored by the instrument 102 as described above is defined as follows:

$$\\ \begin{matrix}{Waveform}_{response} = {Waveform}_{response} ( kT ) & ( Eq . 1 )\end{matrix}$$

where T is the sampling interval of the IQ signal and k=1, 2, . . . , n

Next, the DC (Direct Current) component of the stored waveform is removed from the waveform 402 by performing the following Equation 2.

$$\\ \begin{matrix}{Waveform}_{without DC} = {Waveform}_{response} - mode ( {Waveform}_{response} ) & ( Eq . 2 )\end{matrix}$$

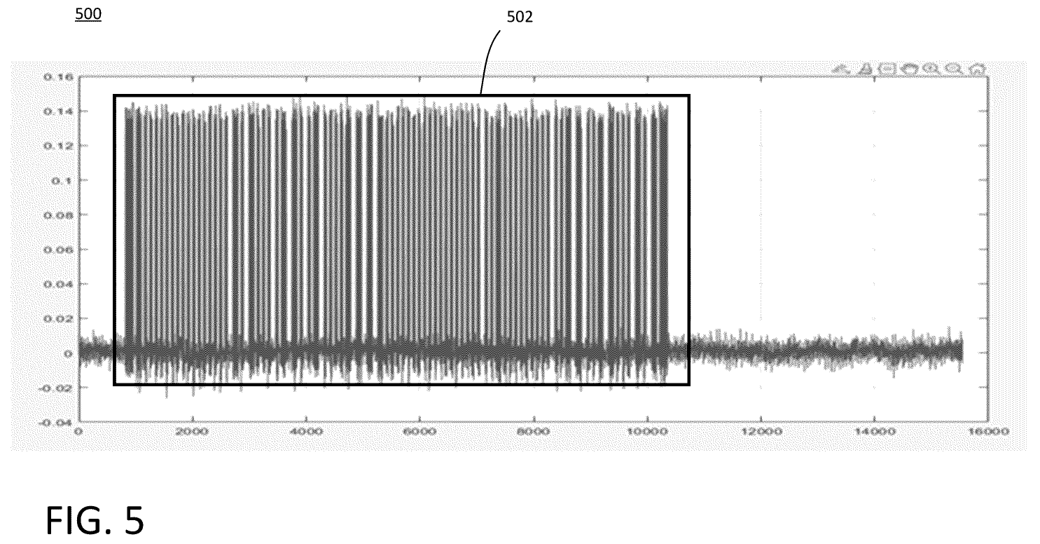

The resulting waveform after the DC component has been removed from the stored waveform 402 is represented in FIG. 5 as reference 502.

Next, the reference SOF waveform is defined as:

$$\\ \begin{matrix}{ReferenceWaveform}_{SOF} = {Waveform}_{SOF} ( zT ) & ( Eq . 3 )\end{matrix}$$

where z={1, . . . , K} and K∈SOF Count.

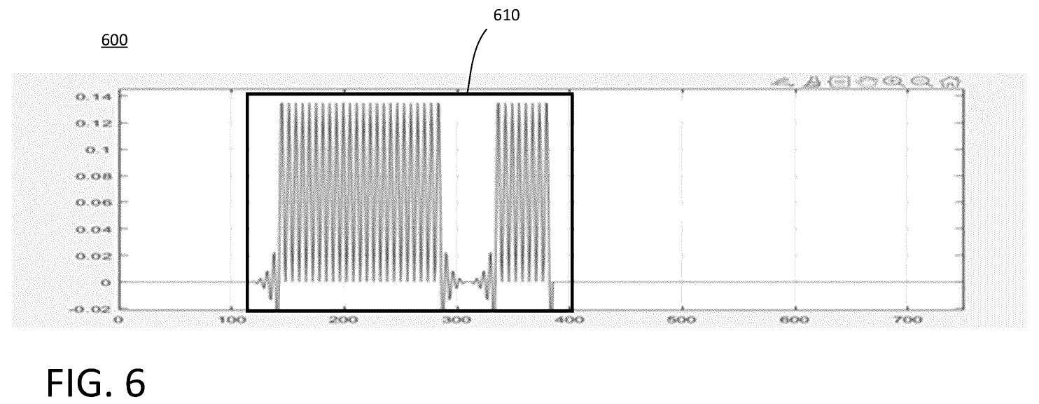

In general, a cross-correlation operation is one where two time-dependent signals are compared to one another to see how they correlate to one another and to determine an amount of lag between the signals. In the above-described case, the two waveforms compared by cross-correlation are the waveform 502, i.e., the acquired waveform 402 after its DC components are removed and the SOF signal waveform represented in FIG. 6 as reference 610.

The cross-correlation command performed in the instrument 102 (FIG. 1) may be represented as:

$$\\ [ {Correlated}_{Data} , Lag ] = corr ( {Waveform}_{without DC} , {ReferenceWaveform}_{SOF} ) .$$

The output of this cross-correlation operation is a cross-correlation function as well as an indication of the associated lags between the two correlated waveforms.

Next, the correlated data produced by the cross-correlation operation may be normalized with an operation of:

$$\\ {CorrelatedData}_{Normalized} = {Correlated}_{Data} / max ( {Correlated}_{Data} ) .$$

This normalized data may then be used in a “response validation operation”, set forth below, which analyzes the results of the cross-correlation as well as the correlated data to generate a response validation ratio. One such example response validation operation is provided below:

Example Response Validation Operation

mean_corr_sof = mean(CorrelatedData_{Normalized}(sof_start:sof_end));
mean_corr_sof_rest = mean(CorrelatedData_{Normalized}(sof_end:sof_start)
if(max(CorrelatedData_{Normalized}>0.8)&& (abs(min(CorrelatedData_{Normalized})) < 0.4) &&
mean_corr_sof >0.3 && mean_corr_sof_rest < 0.25) % calculate valid ratio
val_ratio = abs(max(C21))/abs(min(C21));
end
if(val_ratio > 4 )
is_valid =1;
end.

Referring back to FIG. 3, the response detection operation 310 may be performed by the validation operation set forth above, which determines whether a VICC response is present in one of the pre-defined timeslots following a VCD command. Of course, the validation operation described above is a specific example of such a validation, and it is not required that the particular correlation factors or ratios are used in all embodiments. It is believed, however, that the above example operation provides a very good indication of whether a valid VICC response has been received.

It may be important to note that a Fast Fourier Transform of the stored waveform is not possible, as the signal strength of the VICC response is unknown. Also, the dominant 13.56 MHz carrier signal, such as the WCS 110 of FIG. 1 restricts the ability to accurately locate detectable features in the 848 KHz signal that carries the VICC response.

Once the operation 310 of FIG. 3, by using the validation procedures described above, or variations on them, determines that a VICC response is present in a particular portion of the IQ waveform stored in the instrument 102, then the response can be decoded in an operation 312. The decoding operation may be performed by the response decoder 105 (FIG. 1), which is instructed to operate only when the multi-response detector 104 has determined that a VICC response is present in the stored waveform. The actual decoding of the response performed by the operation 310 extracts digital data from the IQ waveform itself. In some embodiments, the VCD and VICC devices are represented as BUS signals by the instrument 102 (FIG. 1).

After the response has been decoded by the operation 312, or, if it was determined that no response was present in the response period by the operation 310, then the process 310 loops back to operation 306 to find the next response period in the IQ waveform. Because the instrument 102 (FIG. 1) may have large amounts of data storage, the stored IQ waveform may span several seconds, such as 5-10 seconds.

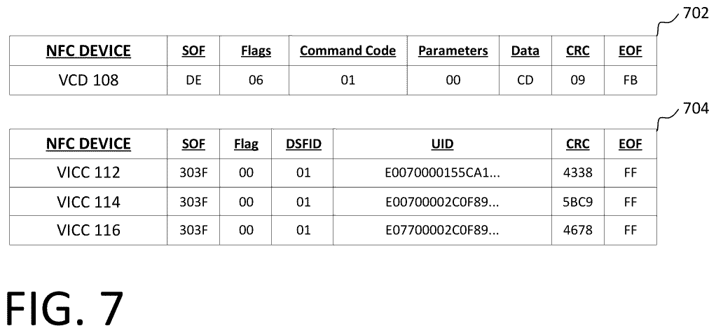

FIG. 7 illustrates example decoded data table 702 from a VCD device, such as the VCD 108 of FIG. 1, as well as example decoded data table 704 from a VICC device, such as the VICCs 112, 114, 116 also illustrated in FIG. 1. One of the decoded fields in the data table 704 is a UID field, which is a unique identifier to the particular VICC device. Once the UID of a VICC device has been detected, the instrument can use the decoded UID to identify commands sent by a VCD to the particular VICC device addressed by the UID. For example, with reference back to FIG. 2B, the system 100 (FIG. 1) can determine that the VCD is sending a request to VICC 112 simply by comparing the UID sent by the VCD to the UID decoded by the decoding process described above.

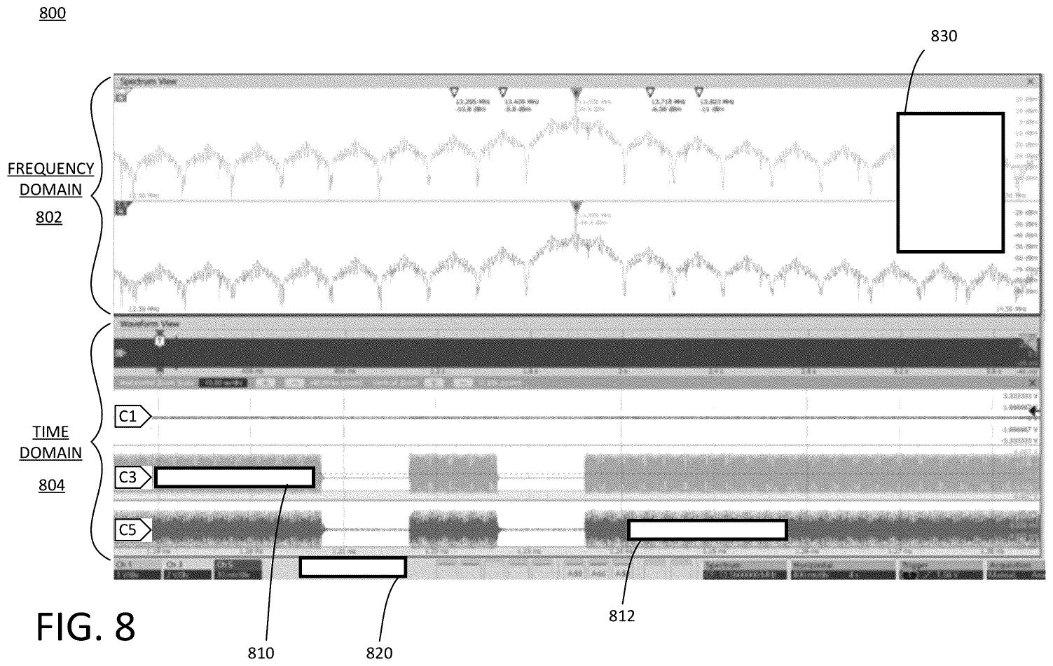

FIG. 8 illustrates an example display screen 800 on which information about the measured and decoded NFC signals may be presented to a user of the instrument 102 (FIG. 1). The display screen 800 may be part of the user interface 154 described above. In general, the display screen 800 is split into two sections, with signals in the frequency domain shown in a section 802, while signals in the time domain are shown in a section 804. Preferably the frequency and time domain sections 802, 804, are aligned with one another relative to the stored IQ signal, and events that occur in either of the domains appear in both sections 802, 804 of the display screen simultaneously.

As described above, one of the features of the testing system 100 is that the response decoder 105 decodes the responses from the IQ signal using the techniques described above. These decoded responses, such as illustrated in the tables 702, 704 of FIG. 7, may also be simultaneously displayed on the display screen. For example, decoded data that was carried by the signal represented by C3 may be shown in a display box 810, or otherwise associated with that particular signal. Similarly, a display box 812 may show data that was decoded from the signal represented by C5. Alternatively, or in addition, decoded data may appear in a display box 820 and labeled with the signal from which the data was decoded. Also, the data could be illustrated in a display box 830. One feature of any of these display boxes is that a user may select particular decoded data, such as by clicking the data with a mouse, and the display screen 800 will refresh to the portion of the IQ signal that contains the selected data. In this way the user can skip through or select particular areas of interest and see the decoded data as well as the signals in the frequency domain section 802 and the time domain section 804 from where the data was decoded.

In general, embodiments of the disclosure allow a user of a testing system to detect the presence of multiple tag responses from NFC devices that occur when a VCD transmits a command, such as an inventory request, captured by the testing system when its RF antenna is proximate to several different NFC listening devices, such as VICCs. Embodiments also include decoding data from data frames transmitted by both the VCDs and VICCs using spectrum processing in an oscilloscope. Embodiments further include aligning and displaying the decoded data along with the time domain signals that correspond to the signals in the frequency domain, thus allowing a user to view a very clear representation of the NFC communication as measured by the oscilloscope.

Aspects of the disclosure may operate on particularly created hardware, on firmware, digital signal processors, or on a specially programmed general-purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. The operations described above may be performed by particular hardware or combinations of hardware and software. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

### EXAMPLES

Illustrative examples of the technologies disclosed herein are provided below. A configuration of the technologies may include any one or more, and any combination of, the examples described below.

Example 1 is a test and measurement system for a Near Field Communication (NFC) system, the test and measurement system including a radio frequency antenna structured to receive a wireless carrier signal generated by an NFC vicinity coupling device and to receive load-modulated wireless carrier signals generated by one or more vicinity integrated circuit cards in response to the wireless carrier signal, and a response detector structured to determine if any load-modulated wireless carrier signals generated by one or more vicinity integrated circuit cards were received by the antenna.

Example 2 is a test and measurement system according to Example 1, in which the response detector is further structured to isolate one or more response time windows following the receipt of the wireless carrier signal, and in which the response detector is structured to determine if any load-modulated wireless carrier signals were received by the antenna during the one or more response time windows.

Example 3 is a test and measurement system according to any of the preceding Examples, in which the response detector is structured to search only the one or more response time windows for load-modulated wireless carrier signals.

Example 4 is a test and measurement system according to any of the preceding Examples, in which the response detector invokes a cross correlation function in determining if any load-modulated wireless carrier signals were received during the one or more response time windows.

Example 5 is a test and measurement system according to Example 4, in which the cross-correlation function comprises generating a cross correlation function using a start-of-frame (SOF) signal as one of a pair of cross-correlated signals.

Example 6 is a test and measurement system according to any of the preceding Examples, further comprising a waveform acquisition system structured to capture the wireless carrier signal received from the antenna, and store the captured signal as a waveform within the test and measurement system.

Example 7 is a test and measurement system according to Example 6, in which the the captured signal is stored as an IQ waveform.

Example 8 is a test and measurement system according to any of the preceding Examples, further comprising a decoder configured to decode data from any load-modulated wireless carrier signals generated by one or more vicinity integrated circuit cards that were received by the antenna, and a display screen for showing the decoded data.

Example 9 is a test and measurement system according to Example 8, in which the display screen is operated to show the received wireless carrier signal on the display screen.

Example 10 is a test and measurement system according to Example 9, in which showing the received wireless carrier signal comprises displaying the wireless carrier signal in a frequency domain and in a time domain on the display simultaneously.

Example 11 is a method of determining presence of a response by a Near Field Communication (NFC) listening device following a command sent by an NFC polling device, including receiving a series of NFC communication signals by an RF antenna attached to an input of a measurement device, detecting that the command was sent by the NFC polling device, isolating one or more valid time periods for the response following the command according to an NFC protocol, and searching for the response in the series of NFC communication signals during only the one or more valid time periods.

Example 12 is a method according to Example 11, further comprising storing the series of NFC communication signals as an IQ waveform, and in which searching for the response comprises analyzing the stored waveform.

Example 13 is a method according to Example 12, in which analyzing the stored waveform comprises performing a cross-correlation function between the stored IQ waveform and a signature waveform.

Example 14 is a method according to Example 13, in which the signature waveform is a start-of-frame (SOF) signal generated by the NFC listening device.

Example 15 is a method according to any preceding Example method, further comprising finding at least one response in the series of NFC communication signals, and decoding data that is encoded in the response.

Example 16 is a method according to Example 15, in which at least two responses are found, and in which data is decoded for each of the found responses.

Example 17 is a method according to Examples 15 or 16, further comprising displaying the decoded data on a display device.

Example 18 is a method according to any preceding Example method, further comprising displaying the received series of NFC communication signals on the display device.

Example 19 is a method according to Example 18, in which displaying the received series of NFC communication signals on the display device comprises displaying the received series of NFC communication signals in a frequency domain and in a time domain simultaneously.

The foregoing description has been set forth merely to illustrate example embodiments of present disclosure and is not intended to be limiting. Since modifications of the disclosed embodiments incorporating the substance of the invention may occur to person skilled in the art, the invention should be construed to include everything within the scope of the invention.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that all features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Also, when reference is made in this application to a method having two or more defined steps or operations, the defined steps or operations can be carried out in any order or simultaneously, unless the context excludes those possibilities.

Although specific examples of the disclosure have been illustrated and described for purposes of illustration, it will be understood that various modifications may be made without departing from the spirit and scope of the disclosure. Accordingly, the disclosure should not be limited except as by the appended claims.

We claim:

1. A test and measurement system for a Near Field Communication (NFC) system, the test and measurement system comprising:
a radio frequency antenna structured to receive a wireless carrier signal generated by an NFC vicinity coupling device and to receive load-modulated wireless carrier signals generated by one or more vicinity integrated circuit cards in response to the wireless carrier signal; and
a response detector structured to determine if any load-modulated wireless carrier signals generated by one or more vicinity integrated circuit cards were received by the antenna.

2. The test and measurement system according to claim 1, in which the response detector is further structured to isolate one or more response time windows following the receipt of the wireless carrier signal, and in which the response detector is structured to determine if any load-modulated wireless carrier signals were received by the antenna during the one or more response time windows.

3. The test and measurement system according to claim 2, in which the response detector is structured to search only the one or more response time windows for load-modulated wireless carrier signals.

4. The test and measurement system according to claim 2, in which the response detector invokes a cross correlation function in determining if any load-modulated wireless carrier signals were received during the one or more response time windows.

5. The test and measurement system according to claim 4, in which the cross-correlation function comprises generating a cross correlation function using a start-of-frame (SOF) signal as one of a pair of cross-correlated signals.

6. The test and measurement system according to claim 1, further comprising a waveform acquisition system structured to:
capture the wireless carrier signal received from the antenna; and
store the captured signal as a waveform within the test and measurement system.

7. The test and measurement system according to claim 6, in which the captured signal is stored as an IQ waveform.

8. The test and measurement system according to claim 1, further comprising:
a decoder configured to decode data from any load-modulated wireless carrier signals generated by one or more vicinity integrated circuit cards that were received by the antenna; and
a display screen for showing the decoded data.

9. The test and measurement system according to claim 8, in which the display screen is operated to show the received wireless carrier signal on the display screen.

10. The test and measurement system according to claim 9, in which showing the received wireless carrier signal comprises displaying the wireless carrier signal in a frequency domain and in a time domain on the display simultaneously.

11. A method of determining presence of a response by a Near Field Communication (NFC) listening device following a command sent by an NFC polling device, comprising:
receiving a series of NFC communication signals by an RF antenna attached to an input of a measurement device;
detecting that the command was sent by the NFC polling device;
isolating one or more valid time periods for the response following the command according to an NFC protocol; and
searching for the response in the series of NFC communication signals during only the one or more valid time periods.

12. The method according to claim 11, further comprising storing the series of NFC communication signals as an IQ waveform, and in which searching for the response comprises analyzing the stored waveform.

13. The method according to claim 12, in which analyzing the stored waveform comprises performing a cross-correlation function between the stored IQ waveform and a signature waveform.

14. The method according to claim 13, in which the signature waveform is a start-of-frame (SOF) signal generated by the NFC listening device.

15. The method according to claim 11, further comprising:
finding at least one response in the series of NFC communication signals; and
decoding data that is encoded in the response.

16. The method according to claim 15, in which at least two responses are found, and in which data is decoded for each of the found responses.

17. The method according to claim 15, further comprising displaying the decoded data on a display device.

18. The method according to claim 11, further comprising displaying the received series of NFC communication signals on the display device.

19. The method according to claim 18, in which displaying the received series of NFC communication signals on the display device comprises displaying the received series of NFC communication signals in a frequency domain and in a time domain simultaneously.
